(19) United States
(12) Patent Application Publication
(10) Pub. No.: US 2007/0062976 A1
(43) Pub. Date: Mar. 22, 2007

(54) Container with a device to discharge product

(76) Inventors: Thorsten Blum, Darmstadt (DE); Stefan Hopp, Ingelheim (DE); Ronald Wienziers, Heusenstamm (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/418,638

(22) Filed: May 5, 2006

(30) Foreign Application Priority Data
May 6, 2005 (DE) 202005007205.2

(51) Int. Cl. G01F 11/10

(52) U.S. Cl. 222/362; 222/359

(57) ABSTRACT

In order to enable removal of any quantity of product with a container (1) with a device (2) to discharge product, particularly trickling or free-flowing product, with a reservoir (3) to hold the product, a product discharge opening (4), and a connection (5) between the reservoir (3) and the device (2), it is suggested that the device (2) have a storage area (11) containing a recess (17) aligned towards the reservoir (3) and an outlet (18) aligned towards the product discharge opening (4), that a rotatable drum (10) be housed in the bearing (11) and the drum (10) have a channel (6), that the channel (6) be aligned in a first alignment towards the recess (17) on one side and towards the outlet (18) on the other, that a closure part (16) on the bearing (1) be used to close the channel (6), and that a manually usable actuator device (9) be provided to act upon the active surface (7), which is connected to the drum (10), to optionally bring the drum (10) into the first alignment so that the channel (6) can be passed by the product or to bring the drum into a second alignment in which the channel (6) is closed by the closure part (16).

The object of the invention relates to a container to discharge product, particularly to provide granulate in the hair salon industry.

Granulate-type hair treatment agent is used in hair salons. Said treatment agent should be manually removable from a container in a simple manner in that the use of one of the user's hands should be sufficient to remove the product so that the user has the other hand available for a different function.

A container according to the preamble of claim 1 is known from DE 34 38 677 A1. This container with a device to discharge product has a reservoir to hold the product, a product discharge opening is used for product exiting, and a connection between the reservoir and the device serves to provide a one-piece design of the container.

The known container has the disadvantage that only one predetermined volumed quantity of product can be discharged from the releasing device. The removal quantity cannot be varied.

The object was to further develop the object according to the preamble of claim 1, which would overcome this disadvantage.

The object is achieved according to the distinguishing component of claim 1. Accordingly, the device has a bearing with a recess aligned towards the reservoir and an outlet aligned towards the product discharge opening. A rotatable drum is housed in the bearing and the drum has a channel. The channel is aligned in a first alignment towards the recess on one side and towards the outlet on the other. A closure part on the bearing is used to close the channel. A manually usable actuator device is provided to act upon the active surface connected to the drum to optionally bring the drum into the first alignment so that the channel can be passed by the product or to bring the drum into a second alignment in which the channel is closed by the closure part.

The suggested container has the advantage that any desired product quantity can be removed. A user can allow a product stream to flow out of the product discharge opening by actuating, from time to time, the actuator device, which is provided for product outlet. In this process, the user is the one that determines the duration of the product output stream for any desired product quantity. The container can be used with one hand in a simple manner. Depending on the alignment of the channel, the product either flows through it or the channel is closed so that no product flow is possible.

Advantageous embodiments of the container according to the invention are described in Claims 2 through 6.

If (according to Claim 2) the actuator device is executed as an actuation knob, which acts upon the active surface via a pin designed on said knob through an opening in the storage area, and if the drum is held, using a spring, in an alignment, preferably in the second alignment, in which the channel is closed by the closure part, then this arrangement ensures both a technically reliable design as well as simple manual actuation of the device to discharge the product. A press of the button is enough to swivel the channel into its product-permeable alignment position. When the actuation knob is released, the channel swivels back into its closed alignment position due to the effect of the spring, and no more product can be discharged.

A surface on a drum recess (Claim 3) is suitable as a sturdy and reliable active surface even with differing drum settings.

A funnel on the connection (Claim 4) routes the product flowing out of the reservoir into the channel.

If the container has a longitudinally extended shape according to Claim 5, on one end of which the product discharge opening is provided, said container can be grasped like a pen and held. For easier holding, even with wet hands, particularly in the hair salon industry, it is advantageous if a container expansion is provided on the end of the container that is opposite the product discharge opening (Claim 6).

The invention is described in detail below with reference to figures that show an exemplary embodiment. The following is shown:

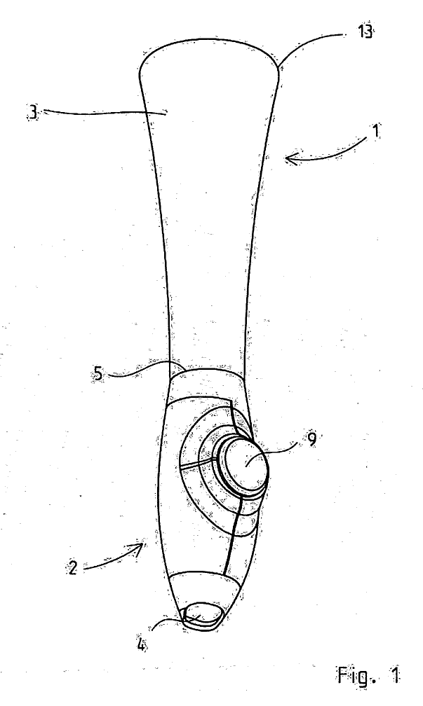

FIG. 1 shows a perspective view of a container with an actuator device designed as an actuation knob to discharge free-flowing product;

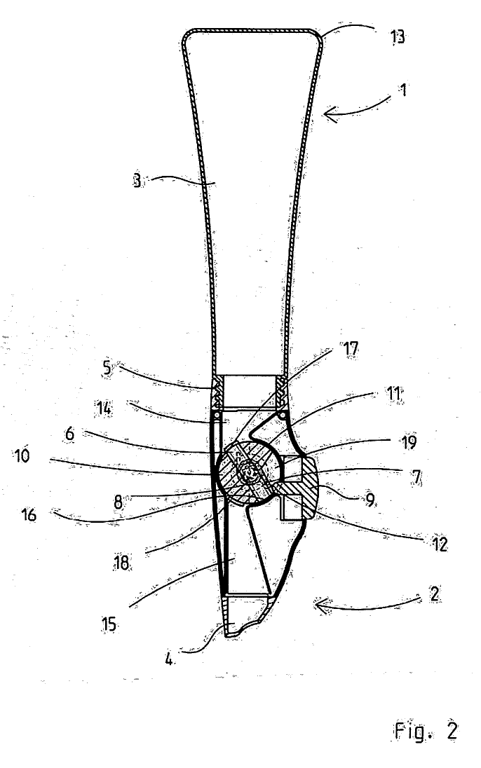

FIG. 2 shows a cut-out of the container according to FIG. 1 with the actuator device not being pressed and thereby with a closed channel; and

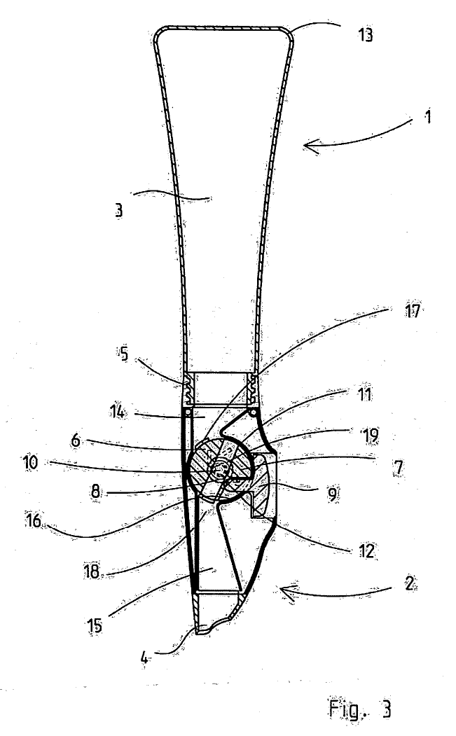

FIG. 3 shows a cut-out of the object according to FIG. 2, but with the actuator device being pressed and thereby a free channel for product discharge.

A container 1 (FIG. 1) has a device 2 to discharge product, particularly trickling or free-flowing product, with a reservoir 3 to hold the product, and a product discharge opening 4 has a connection 5 between the reservoir 3 and the device 2, which is executed as a screw connection.

The device 2 has a bearing 11 containing a recess 17 aligned towards the reservoir 3 and an outlet 18 aligned towards the product discharge opening 4 (FIG. 2). A rotatable drum 10 is housed in the bearing 11 and the drum has a channel 6. The channel 6 is aligned in a first alignment (FIG. 3) towards both the recess 17 and the outlet 18. A closure part 16 on the bearing 11 is used to close the channel 6. A manually usable actuator device 9 is provided to act upon the active surface 7, which is executed in a drum recess 19 and connected to the drum 10, to optionally bring the drum 10 into the first alignment so that the channel 6 can be passed by the product or to bring the drum into a second alignment (FIG. 2) in which the channel 6 is closed by the closure part 16.

The actuator device 9 is executed as an actuation knob, which acts upon the active surface 7 via a pin 12 designed on said knob through an opening in the bearing 11. The drum 10 is held in an alignment, in which the channel 6 is closed by the closure part 16, using a spring 8.

The container 1 is held downwards in order to dispense the product with the product discharge opening 4, wherein product flows from the reservoir 3 through a funnel 14 into the channel 6. A container expansion 13 is provided, on the end of the longitudinally extended container 1 that is opposite the product discharge opening 4, for improving manually holding the container 1, which can be used with one hand.

### REFERENCE LIST

1 Container
2 Device
3 Reservoir
4 Product discharge opening
5 Connection
6 Channel
7 Active surface
8 Spring
9 Actuator device
10 Drum
11 Bearing
12 Pin
13 Container expansion
14 Funnel
15 Discharge channel
16 Closure part
17 Recess
18 Outlet
19 Drum recess

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container (1) with a device (2) to discharge product, particularly trickling or free-flowing product, comprising a reservoir (3), a product discharge opening (4), and a connection (5) between the reservoir (3) and the device (2), wherein the device (2) comprises a bearing (11) containing a recess (17) aligned towards the reservoir (3) and an outlet (18) aligned towards the product discharge opening (4), wherein a rotatable drum (10) is housed in the bearing (11) and the drum (10) comprises a channel (6), wherein the channel (6) is aligned in a first alignment towards the recess (17) on one side and towards the outlet (18) on the other, wherein a closure part (16) on the bearing (11) is operable to close the channel (6), and wherein a manually usable actuator device (9) is provided to act upon the active surface (7), which is connected to the drum (10), to optionally bring the drum (10) into the first alignment so that the channel (6) can be passed by the product or to bring the drum into a second alignment in which the channel (6) is closed by the closure part (16).

2. A container according to claim 1, wherein the actuator device (9) is executed as an actuation knob, which acts upon the active surface (7) via a pin (12) designed on said knob through an opening in the bearing (11), and wherein the drum (10) is held, using a spring (8), in an alignment, preferably in the second alignment, in which the channel is closed (6) by the closure part (16).

3. A container according to claim 2, wherein the active surface (7) is provided on a drum recess (19).

4. A container according to claim 1, wherein a funnel (14) is provided between the connection (5) and the recess (17).

5. A container according to claim 1, wherein the container (1) has a longitudinally extended shape, on one end of which the product discharge opening (4) is provided.

6. A container according to claim 5, wherein a container expansion (13) is provided on the opposite end.
